(19) United States
(12) Patent Application Publication
(10) Pub. No.: US 2025/0349940 A1
(43) Pub. Date: Nov. 13, 2025

(54) INSULATION SHEET AND BATTERY MODULE

(71) Applicant: SAMSUNG SDI CO., LTD., Yongin-si (KR)

(72) Inventors: Jung Hyo LEE, Suwon-si (KR); A Rum YU, Suwon-si (KR); Myung Heui WOO, Suwon-si (KR); Seung Yong YANG, Suwon-si (KR); Hye Jin PARK, Suwon-si (KR); Jae Hyun LEE, Suwon-si (KR); Ha Na RA, Suwon-si (KR); Yun Sung YANG, Suwon-si (KR)

(73) Assignee: SAMSUNG SDI CO., LTD., Yongin-si (KR)

(21) Appl. No.: 19/089,415

(22) Filed: Mar. 25, 2025

(30) Foreign Application Priority Data
May 9, 2024 (KR) 10-2024-0061247

(51) Int. Cl. H01M 10/658; H01M 10/647

(52) U.S. Cl. CPC H01M 10/658; H01M 10/647

(57) ABSTRACT

The present disclosure relates to an insulation sheet, and a battery module including the insulation sheet. The insulation sheet includes one or more first layers, and one or more second layers alternately stacked with the first layers, wherein at least one of the one or more second layers includes an insulation material and an additive configured to improve a coating uniformity thereof.

### CROSS-REFERENCE TO RELATED APPLICATION

The present application claims priority to Korean Patent Application No. 10-2024-0061247, filed on May 9, 2024 in the Korean Intellectual Property Office, and the entire disclosure of which is incorporated herein by reference.

### BACKGROUND

### 1. Field of the Disclosure

The present disclosure relates to an insulation sheet, and a rechargeable battery module including the insulation sheet.

### 2. Discussion of Related Art

With increasing presence of electronic devices using batteries, such as, e.g., mobile phones, notebook computers, electric vehicles, and the like, demand for rechargeable batteries with high energy density and high capacity has increased. Accordingly, improving the performance of rechargeable lithium batteries may be advantageous.

A rechargeable lithium battery includes a positive electrode and a negative electrode, each including an active material capable of intercalating and deintercalating lithium ions, and an electrolyte. In the rechargeable lithium battery, electrical energy is produced through oxidation and reduction reactions when lithium ions are intercalated into and deintercalated from the positive electrode and the negative electrode.

As technology advances and/or interest in the environment increases, the number of devices in which such rechargeable batteries are included is increasing. Accordingly, demand for high-capacity rechargeable batteries is increasing.

High-capacity rechargeable batteries are typically manufactured in the form of modules and/or packs manufactured by stacking a plurality of rechargeable batteries. However, as a plurality of rechargeable batteries are disposed adjacent to each other, heat propagation between adjacent cells may become easier. When thermal runaway occurs in one cell, the thermal runaway may readily spread to adjacent cells, resulting in hazards such as fire that may threaten safety.

Therefore, a method of reducing or preventing heat propagation between adjacent cells may be advantageous.

### SUMMARY

One example embodiment includes an insulation sheet that reduces or prevents heat propagation, and/or a rechargeable battery module including the insulation sheet.

Another example embodiment includes an insulation sheet in which a coating layer has improved uniformity, and/or a rechargeable battery module including the insulation sheet.

Still another example embodiment includes an insulation sheet with improved thermal conductivity, and/or a rechargeable battery module including the insulation sheet.

Yet another example embodiment includes an insulation sheet with improved fire resistance properties and/or mechanical strength, and/or a rechargeable battery module including the insulation sheet.

According to an example aspect of the present disclosure, an insulation sheet includes one or more first layers, and one or more second layers alternately stacked with the first layers, wherein the second layer includes an insulation material and an additive.

According to another example aspect of the present disclosure, a battery module includes a plurality of battery cells, the insulation sheet located in at least one gap between the plurality of battery cells, and a housing in which the battery cell and the insulation sheet are accommodated.

### BRIEF DESCRIPTION OF THE DRAWINGS

The accompanying drawings illustrate example embodiments of the present disclosure and, together with the following detailed description, be configured to provide further understanding of the technical spirit of the present disclosure. However, the present disclosure is not to be construed as being limited to the details shown in the drawings, in which:

FIGS. 1 to 4 are views illustrating rechargeable lithium batteries according to one embodiment;

FIG. 5 is a view illustrating a battery module according to one embodiment;

FIG. 6 is a perspective view of a battery cell according to one embodiment;

FIG. 7 is a cross-sectional view of an insulation sheet according to one embodiment;

FIG. 8 is a cross-sectional view of an insulation sheet according to one embodiment;

FIG. 9 is a cross-sectional view of an insulation sheet according to one embodiment;

FIG. 10 is a cross-sectional view of an insulation sheet according to one embodiment;

FIG. 11 is a cross-sectional view of an insulation sheet according to one embodiment; and

FIG. 12 is a cross-sectional view of an insulation sheet according to one embodiment.

### DETAILED DESCRIPTION

Hereinafter, example embodiments of the present disclosure are described in detail. However, these embodiments are merely examples, the present disclosure is not limited thereto, and the present disclosure is defined by the scope of claims.

Unless otherwise specified herein, it is understood that when a component, such as a layer, a film, a region, or a plate, is referred to as being “on” another component, the component may be “directly on” the other component or intervening components may be present thereon.

Unless otherwise specified herein, singular forms may include plural forms. In addition, unless otherwise specified, “including A or B” may mean three cases, namely, “the case including A, the case including B, and the case including A and B.”

As used herein, “combination thereof” may refer to a mixture, a stacked structure, a composite, a copolymer, an alloy, a blend, or a reaction product of components.

Unless otherwise defined herein, a particle diameter may be an average particle diameter. For example, a particle diameter refers to an average particle diameter (D50) which refers to a diameter of particles with a cumulative volume of 50 vol % in a particle size distribution. The average particle diameter (D50) may be measured through methods known to those skilled in the art, for example, by using a particle size analyzer, a transmission electron microscope image, or a scanning electron microscope image. Through other methods, measurement may be performed using a measuring device using dynamic light-scattering, data analysis is performed to count the number of particles for each particle size range, and then a value of the average particle diameter (D50) may be readily obtained therefrom through calculation. In other example embodiments, the average particle diameter (D50) may be measured using a laser diffraction method. During measurement through laser diffraction, for example, particles to be measured may be dispersed in a dispersion medium to then be introduced into a commercially available laser diffraction particle diameter measuring device (for example, Microtrac MT 3000), 28 kHz ultrasonic waves may be radiated thereon at an output power of about 60 W, and then the average particle size (D50) based on 50% of a particle diameter distribution may calculated in the measuring device.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

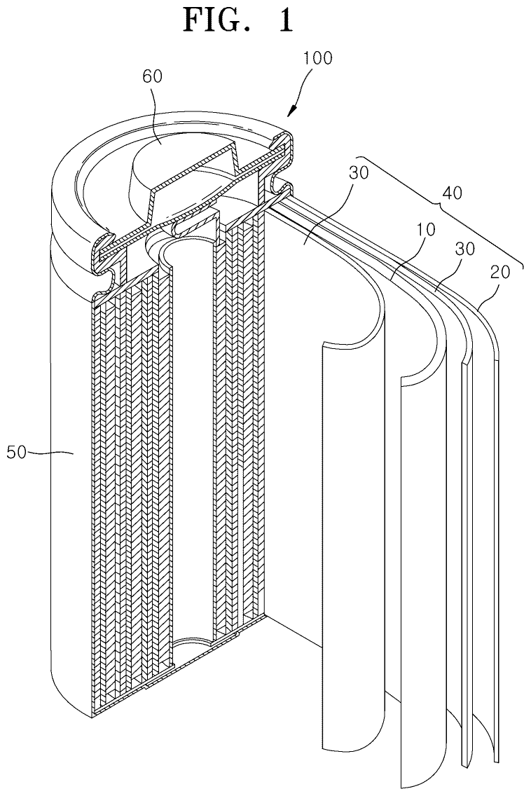

FIGS. 1 to 4 are views illustrating rechargeable lithium batteries, according to one example embodiment.

### Rechargeable Lithium Battery 100

The rechargeable lithium battery 100 may be classified into cylindrical, prismatic, pouch-type, coin-type batteries according to the shape thereof. FIGS. 1 to 4 are schematic views illustrating the rechargeable lithium batteries, according to one example embodiment, wherein FIG. 1 illustrates a cylindrical battery, FIG. 2 illustrates a prismatic battery, and FIGS. 3 and 4 illustrate pouch-type batteries. Referring to FIGS. 1 to 4, the rechargeable lithium battery 100 may include an electrode assembly 40 with a separator 30 interposed between a positive electrode 10 and a negative electrode 20, and a case 50 in which the electrode assembly 40 is embedded. The positive electrode 10, the negative electrode 20, and the separator 30 may be impregnated with an electrolyte (not shown). As shown in FIG. 1, the rechargeable lithium battery 100 may include a sealing member 60 that seals the case 50. In addition, in FIG. 2, the rechargeable lithium battery 100 may include a positive electrode lead tab 11, a positive electrode terminal 12, a negative electrode lead tab 21, and a negative electrode terminal 22. As shown in FIGS. 3 and 4, the rechargeable lithium battery 100 may include an electrode tab 70 illustrated in FIG. 4, or a positive electrode tab 71 and a negative electrode tab 72 illustrated in FIG. 3, is configured the electrode tabs 70/71/72 forming an electrical path for guiding a current generated in the electrode assembly 40 to the outside of the battery 100.

### Positive Electrode Active Material

As a positive electrode active material, a compound (lithiated intercalation compound) capable of reversibly intercalating and deintercalating lithium may be included. For example, at least one composite oxide of lithium and a metal such as or including at least one of cobalt, manganese, nickel, and a combination thereof may be included.

The composite oxide may be a lithium transition metal composite oxide, and examples thereof may include at least one of lithium nickel-based oxide, lithium cobalt-based oxide, lithium manganese-based oxide, a lithium iron phosphate-based compound, cobalt-free nickel-manganese-based oxide, or a combination thereof.

As an example, a compound represented by any one of formulas below may be used: LiₐA_{1-b}X_{b}O_{2-c}D_{c}, wherein 0.90≤a≤1.8, 0≤b≤0.5, and 0≤c≤0.05; LiₐMn_{2-b}X_{b}O_{4-c}D_{c}, wherein 0.90≤a≤1.8, 0≤b≤0.5, and 0≤c≤0.05; LiₐNi_{1-b-c}Co_{b}X_{c}O_{2-α}D_{α}, wherein 0.90≤a≤1.8, 0≤b≤0.5, 0≤c≤0.5, and 0<α<2; LiₐNi_{1-b-c}Mn_{b}X_{c}O_{2-α}D_{α}, wherein 0.90≤a≤1.8, 0≤b≤0.5, 0≤c≤0.5, and 0<α<2; LiₐNi_{b}Co_{c}L¹_{d}GₑO₂, wherein 0.90≤a≤1.8, 0≤b≤0.9, 0≤≤0.5, 0≤d≤0.5, and 0≤e≤0.1; LiₐNiG_{b}O₂, wherein 0.90≤a≤1.8 and 0.001≤b≤0.1; LiₐCoG_{b}O₂, wherein 0.90≤a≤1.8 and 0.001≤b≤0.1; LiₐMn_{1-b}G_{b}O₂, wherein 0.90≤a≤1.8 and 0.001≤b≤0.1; LiₐMn₂G_{b}O₄, wherein 0.90≤a≤1.8 and 0.001≤b≤0.1; LiₐMn_{1-g}G_{g}PO₄, wherein 0.90≤a≤1.8 and 0≤g≤0.5; Li_{(3-f)}Fe₂(PO₄)₃, wherein 0≤f≤2; and LiₐFePO₄, wherein 0.90≤a≤1.8.

In the above formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

As an example, the positive electrode active material may be or include a high-nickel-based positive electrode active material in which, in the lithium transition metal composite oxide, a content of nickel is about 80 mol % or more, 85 mol % or more, 90 mol % or more, 91 mol % or more, or in a range of about 94 mol % to about 99 mol % with respect to 100 mol % of a metal excluding lithium. The high-nickel-based positive electrode active material may exhibit high capacity, and may thus be applied to high-capacity and high-density rechargeable lithium batteries.

Positive electrode 10

The positive electrode 10 for the rechargeable lithium battery 100 may include a current collector, and a positive electrode active material layer formed on the current collector. The positive electrode active material layer may include a positive electrode active material, and may further include a binder and/or a conductive material.

As an example, the positive electrode may further include an additive that may be configured as a sacrificial positive electrode.

A content of the positive electrode active material may be in a range of about 90 wt % to about 99.5 wt % with respect to 100 wt % of the positive electrode active material layer, and a content of each of the binder and the conductive material may be in a range of about 0.5 wt % to about 5 wt % with respect to 100 wt % of the positive electrode active material layer.

The binder may be configured to readily attach positive electrode active material particles to each other, and also to readily attach the positive electrode active material to the current collector. Representative examples of the binder may include at least one of polyvinyl alcohol (PVA), carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, and the like, but the present disclosure is not limited thereto.

The conductive material may be included to impart conductivity to an electrode, and any electron-conductive material may be included as long as the electron-conductive material may not cause a chemical change in a battery to be made. Examples of the conductive material may include a carbon-based material such as or including at least one of natural graphite, artificial graphite, carbon black, acetylene black, Ketjen black, carbon fiber, carbon nanofibers, or carbon nanotubes; a metal-based material containing at least one of copper, nickel, aluminum, silver, and the like, and being in the form of a metal powder or metal fiber; a conductive polymer such as a polyphenylene derivative; or a mixture thereof.

Aluminum (Al) may be included as the current collector, but the present disclosure is not limited thereto.

### Negative Electrode Active Material

A negative electrode active material includes at least one of a material capable of reversibly intercalating/deintercalating lithium ions, a lithium metal, a lithium metal alloy, a material capable of doping and undoping lithium, or a transition metal oxide.

The material capable of reversibly intercalating/deintercalating lithium ions may include a carbon-based negative electrode active material, for example, crystalline carbon, amorphous carbon, or a combination thereof. Examples of the crystalline carbon may include graphite such as at least one of natural graphite or artificial graphite having a shapeless, plate-like, flake-like, spherical, or fibrous form. Examples of the amorphous carbon may be include at least one of soft carbon, hard carbon, mesophase pitch carbide, or fired coke.

The alloy of the lithium metal may include an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

As the material capable of doping and undoping lithium, a Si-based negative electrode active material or a Sn-based negative electrode active material may be included. The Si-based negative electrode active material may be or include at least one of silicon, a silicon-carbon composite, SiOₓ, wherein 0<x<2, a Si-Q alloy, wherein Q is or includes at least one of an alkali metal, an alkaline earth metal, a Group 13 element, or a Group 14 element (excluding Si), a Group 15 element, a Group 16 element, a transition metal, a rare earth element, and a combination thereof, or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may include silicon particles and amorphous carbon, and the surfaces of the silicon particles are coated. For example, the silicon-carbon composite may include a secondary particle (core) formed by bonding silicon primary particles and an amorphous carbon coating layer (shell) located on a surface of the secondary particle. The amorphous carbon may also be located between the silicon primary particles, and thus, for example, the silicon primary particles may be coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer on a surface of the core.

The Si-based negative electrode active material or Sn-based negative electrode active material may be included after mixing with a carbon-based negative electrode active material.

### Negative Electrode 20

The negative electrode 20 for the rechargeable lithium battery 100 includes a current collector, and a negative electrode active material layer on the current collector. The negative electrode active material layer may include a negative electrode active material, and may further include a binder and/or a conductive material.

For example, the negative electrode active material layer may include the negative electrode active material in a content in a range of about 90 wt % to about 99 wt %, the binder in a content in a range of about 0.5 wt % to about 5 wt %, and the conductive material in a content in a range of about 0 wt % to about 5 wt %.

The binder is configured to attach negative electrode active material particles to each other, and to attach the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, PVA, and a combinations thereof.

When the aqueous binder is included as the binder of the negative electrode, the aqueous binder may further include a cellulose-based compound capable of imparting viscosity. As the cellulose-based compound, one or more types of carboxymethyl cellulose, hydroxypropylmethyl cellulose, methyl cellulose, and an alkali metal salt thereof, may be mixed. As the alkali metal, at least one of Na, K, or Li may be included.

The dry binder may include a polymer material capable of being fiberized, for example, at least one of polytetrafluoroethylene, polyvinylidene fluoride, a polyvinylidene fluoride-hexafluoropropylene copolymer, polyethylene oxide, or a combination thereof.

The conductive material may be included to impart conductivity to an electrode, and any electron-conductive material may be included as long as the electron-conductive material may not cause a chemical change in a battery to be made. Examples of the conductive material may include a carbon-based material such as or including at least one of natural graphite, artificial graphite, carbon black, acetylene black, Ketjen black, carbon fiber, carbon nanofibers, or carbon nanotubes; a metal-based material containing at least one of copper, nickel, aluminum, silver, and the like, and having a form of a metal powder or metal fiber; a conductive polymer such as a polyphenylene derivative; or a mixture thereof.

The current collector of the negative electrode may be or include at least one of copper foil, nickel foil, stainless steel foil, titanium foil, nickel foam, copper foam, a polymer substrate coated with a conductive metal, and a combination thereof.

### Electrolyte (not Shown)

An electrolyte for the rechargeable lithium battery 100 includes a non-aqueous organic solvent and a lithium salt.

The non-aqueous organic solvent is configured as a medium through which ions involved in an electrochemical reaction of a battery may move.

The non-aqueous organic solvent may be or include at least one of a carbonate-based solvent, an ester-based solvent, ether-based, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In some example embodiments, the ketone-based solvent may include cyclohexanone and the like. The alcohol-based solvent may include at least one of ethyl alcohol, isopropyl alcohol, and the like. The aprotic solvent may include at least one of nitriles such as R—CN wherein R is a C₂-C₂₀ linear, branched, or ring structure hydrocarbon group and includes a double bond, an aromatic ring, or an ether group; amides such as dimethylformamide; dioxolanes such as 1,3-dioxolane and 1,4-dioxolane; sulfolanes, and the like.

The non-aqueous organic solvent may be included alone or in combination of two or more types of solvents.

In addition, when the carbonate-based solvent is included, cyclic carbonate and chain carbonate may be mixed, and the cyclic carbonate and the chain carbonate may be mixed at a volume ratio of about 1:1 to about 1:9.

The lithium salt may be or include a material that is configured to dissolve in an organic solvent, is configured as a source of lithium ions in a battery, is configured to enable the basic operation of a rechargeable lithium battery, and is configured to promote the movement of lithium ions between a positive electrode and a negative electrode. Representative examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide LiC₄F₉SO₃, LiN(CₓF₂ₓ₊₁SO₂)(C_{y}F_{2y+1}SO₂), wherein x and y are each an integer from 1 to 20, lithium trifluoromethane sulfonate, lithium etrafluoroethanesulfonate, lithium difluorobis(oxalato) phosphate (LiDFOB), and lithium bis(oxalato) borate (LiBOB).

### Separator 30

According to the type of the rechargeable lithium battery 100, the separator 30 may be present between the positive electrode 10 and the negative electrode 20. As the separator 30, at least one of polyethylene, polypropylene, polyvinylidene fluoride, or a multilayer thereof having two or more layers may be included, and a mixed multilayer such as a polyethylene/polypropylene double-layered separator, a polyethylene/polypropylene/polyethylene triple-layered separator, or a polypropylene/polyethylene/polypropylene triple-layered separator may be included.

The separator 30 may include a porous substrate and a coating layer which includes an organic material, an inorganic material, or a combination thereof, and is located on one surface, or on both surfaces, of the porous substrate.

The porous substrate may be or include a polymer film formed of or including any one polymer such as at least one of polyolefin such as polyethylene, or polypropylene, polyester such as polyethylene terephthalate or polybutylene terephthalate, polyamide, polyimide, polycarbonate, polyether ketone, polyaryl ether ketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or a copolymer or mixture of two or more types thereof.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic material and the inorganic material may be mixed and present in one coating layer, or may be in a form in which a coating layer including an organic material and a coating layer including an inorganic material are stacked together.

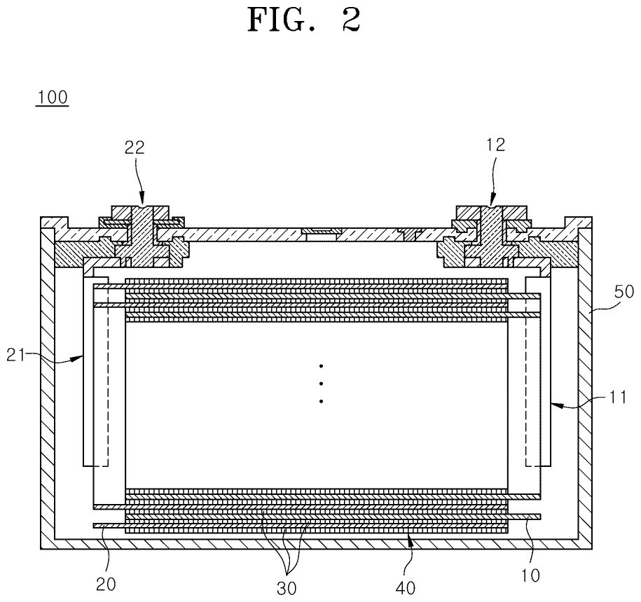

FIG. 5 is a schematic view illustrating a battery module, according to one example embodiment.

Referring to FIG. 5, a battery module 1000 according to examples of the present disclosure includes a plurality of battery cells 100 (for example, including the rechargeable lithium battery 100 described with reference to FIGS. 1 to 4) arranged in one direction, and a housing 1061, 1062, 1063, and 1064 in which the plurality of battery cells 100 are accommodated.

The housing 1061, 1062, 1063, and 1064 may include a pair of end plates 1061 and 1062 facing a wide surface of the battery cell 100, and side plates 1063 and a bottom plate 1064 which connect the pair of end plates 1061 and 1062. The side plate 1063 supports a side surface of the battery cell 100, and the bottom plate 1064 supports a bottom surface of the battery cell 100. In addition, the pair of end plates 1061 and 1062, the side plate 1063, and the bottom plate 1064 may be connected by members such as bolts 1065 or the like.

The battery cell 100 according to one example embodiment (for example, including the rechargeable lithium battery 100 described with reference to FIGS. 1 to 4) and/or the battery module 1000 including the plurality of battery cells 100, have been described in detail with reference to FIG. 5. Hereinafter, a method of reducing or preventing heat propagation inside and outside the battery cell 100 and/or the battery module 1000 in which the plurality of battery cells 100 are located adjacent to each other are described.

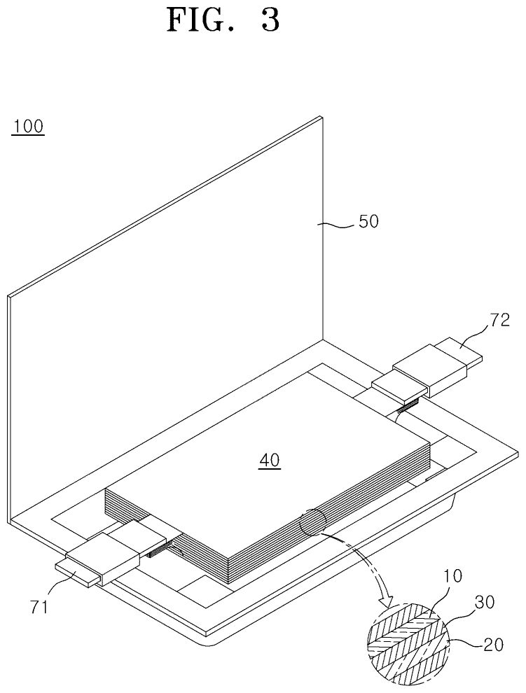

FIG. 6 is a perspective view of a battery cell according to one embodiment. FIG. 6 schematically illustrates the plurality of battery cells 100 located inside the battery module 1000 described with reference to FIG. 5. In FIG. 6, for convenience of description, the housing 1061, 1062, 1063, and 1064 accommodating the battery cells 100 are omitted.

The battery module 1000 includes the plurality of battery cells 100 arranged parallel to each other, and electrically connected in series or parallel. Although FIG. 6 illustrates an example in which the battery module 1000 includes four battery cells 100, the battery module 1000 according to one example embodiment may include more than four battery cells 100, or less that four battery cells 100. The number of battery cells 100 included in the battery module 1000 may vary according to a device to which the battery module 1000 is applied.

The battery module 1000 may further include one or more insulation sheets 200. The insulation sheet 200 is provided at one side and/or both sides of the battery cell 100. For example, the insulation sheet 200 is provided between two battery cells 100. As another example, the insulation sheet 200 is provided between one or more of the plurality of battery cells 100. Alternatively, for example, the insulation sheet 200 is provided between the housing 1061, 1062, 1063, and 1064 and the battery cell 100.

The insulation sheet 200 may be configured to hinder or block heat generated from the battery cell 100 located at one side of the insulation sheet 200. For example, the insulation sheet 200 hinders or blocks heat from being transferred from one battery cell 100 to another battery cell 100 adjacent to the one battery cell.

For example, the insulation sheet 200 has a small thickness and may be similar to a thin plate, a thin film, or a sheet, and has a form that receives tension. Accordingly, the insulation sheet 200 may be readily applied even in a narrow space such as, e.g., a space between two battery cells 100, or a space between the battery cell 100 and the housing 1061, 1062, 1063, and 1064. For example, the insulation sheet 200 is attached to one surface of the battery cell 100 through an adhesive. As another example, the insulation sheet 200 is sandwiched between two battery cells 100 and fixed to the battery cells 100.

For example, even when a thermal runaway phenomenon occurs inside the battery module 1000, heat transfer between the battery cells 100 may be reduced or prevented, and the safety of the battery cell 100 and/or the battery module 1000 may be improved.

Hereinafter, the structure of the insulation sheet 200 is described in detail.

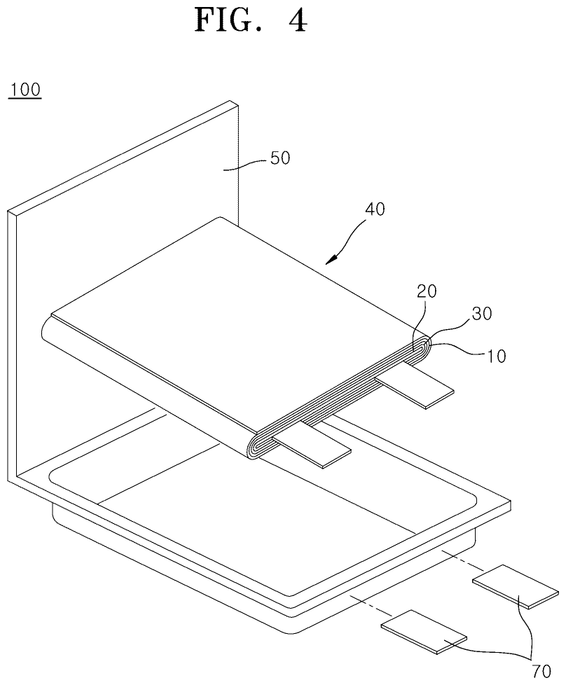

FIG. 7 is a cross-sectional view of an insulation sheet, according to one example embodiment.

In FIG. 7, the reference numeral 200 denotes the insulation sheet 200 described above with reference to FIG. 6.

The insulation sheet 200 according to one example embodiment includes a first layer 210 and a second layer 220.

The first layer 210 is a substrate of the insulation sheet 200. The first layer 210 may maintain the shape of the insulation sheet 200. In addition, the first layer 210 is configured as a barrier for hindering or blocking heat diffusion. Due to the characteristics of the insulation sheet 200, components included in the insulation sheet 200 may not be deformed by heat or may not damage the neighboring battery cells 100 by heat. Accordingly, the insulation sheet 200 may have sufficient insulation and/or heat resistance properties while maintaining a shape thereof.

For example, the first layer 210 is made of or includes at least one of mica, or a mixture of two or more of, fiber, sericite, talc, diatomaceous earth, bentonite, silicon, elvan, kaolin, polyimide, and polyethylene terephthalate.

The second layer 220 is configured as an insulation layer that allows the insulation sheet 200 to have insulation properties. The second layer 220 reduces or suppresses heat from being diffused from one battery cell 100 to another battery cell 100 adjacent to the one battery cell 100.

For example, the second layer 220 is made of or includes at least one of, or a mixture of two or more of, aerogel, wet silica, dry silica, polyurethane, polystyrene, polyethylene, and polyester.

The second layer 220 is stacked on at least one surface of the first layer 210. In this case, the second layer 220 may be stacked on one surface of the first layer 210 while being in contact with the one surface of the first layer 210. Alternatively, the second layer 220 may be stacked on one surface of the first layer 210 while being spaced apart from the one surface of the first layer 210.

The second layer 220 is, for example, a sheet. The second layer 220 is configured to be attached onto the first layer 210.

For example, the second layer 220 is made of or includes, for example, a slurry or a solution. The second layer 220 may be formed on the first layer 210 through, e.g., coating, spraying, and/or applying.

Through such a configuration, the insulation sheet 200 according to one example embodiment can reduce or prevent heat from propagating between the plurality of adjacent battery cells 100.

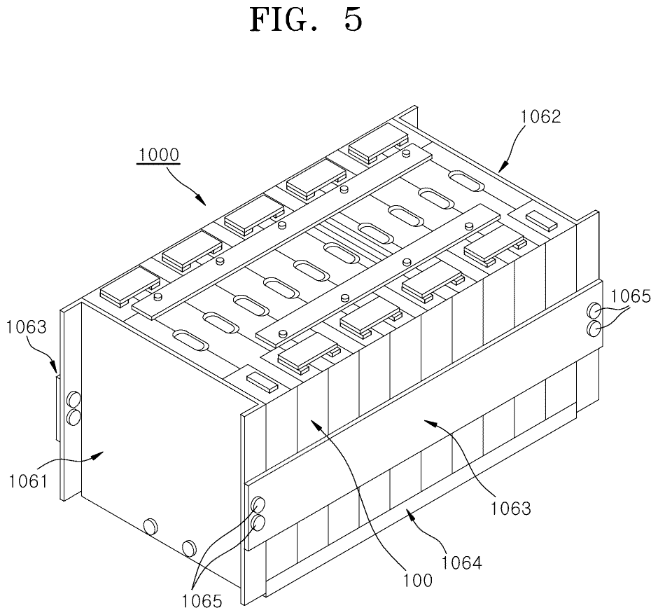

FIG. 8 is a cross-sectional view of an insulation sheet, according to one example embodiment.

In FIG. 8, the reference numeral 200 denotes the insulation sheet 200 described above with reference to FIGS. 6 and 7.

The insulation sheet 200 according to one example embodiment includes a first layer 210 and a second layer 220.

As shown in FIG. 8, the insulation sheet 200 has a configuration in which the first layer 210 and the second layer 220 are alternately stacked. For example, the insulation sheet 200 may include two first layers 210, and the second layer 220 located between the two first layers 210.

Through such a configuration, the first layer 210 according to one example embodiment allows the second layer 220 to be further supported. In addition, the first layer 210 can reduce or prevent external damage to the second layer 220.

For example, the insulation sheet 200 according to one example embodiment may provide an improved effect by further including an additional additive added to the second layer 220 as described below.

The additive is, for example, at least one of a leveling agent, a defoamer, a dispersant, and a combination or mixture thereof. The additive is added to the second layer 220 to improve the coating uniformity of the second layer 220 with respect to the first layer 210. Accordingly, the second layer 220 may have improved insulation and/or fire resistance properties through increased yield and removal of micropores in a coating layer.

For example, the leveling agent has an effect of improving the uniformity of the coating layer, and reducing or preventing the occurrence of defects. Accordingly, the leveling agent may allow the aerogel to be more uniformly applied, and may increase the density of the aerogel.

For example, the defoamer may remove air bubbles in an aerogel coating layer to increase the density of the second layer 220.

For example, the dispersant may increase a degree of dispersion of silica particles of aerogel to increase the density of the second layer 220. When the aerogel density of the second layer 220 increases, the insulation and/or fire resistance properties of the insulation sheet 200 improve. In addition, the insulation sheet 200 has a uniform coating layer, thereby improving yield.

The additive is or includes at least one of a silicone-based polymer, a polyester-based polymer, a fluorine-based polymer, and a combination thereof. The additive includes, for example, products commercially available.

The additive may include, for example, a compound according to Formula 1 and/or Formula 2 below.

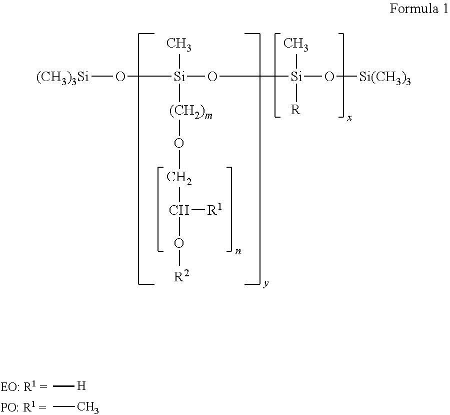

In this case, Formula 1 includes, for example, BYK-019 manufactured by BYK-Chemie GmbH.

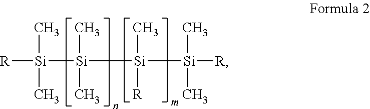

In this case, Formula 2: includes, for example, BYK-348 manufactured by BYK-Chemie GmbH.

In this case, in Formula 2, R includes, for example, functional modifications such as BYK®-UV3510 (manufactured by BYK-Chemie GmbH, Wesel, Germany) and BYK®-348 (manufactured by BYK-Chemie GmbH), and fluoro surfactants such as Zonyl® FSO-100 (manufactured by E.I. Du Pont de Nemours and Co., Wilmington, DE). In addition, R denotes, for example, a formula of RfCH₂CH₂O(CH₂CH₂O)ₓH, wherein Rf═F(CF₂CF₂)_{y}, x may be in a range of 0 to 15, and y may be in a range of 1 to 7.

Alternatively, the additive is or includes, for example, an impact-resistant binder. The additive is added to the second layer 220 to improve the impact resistance of the second layer 220. Accordingly, the second layer 220 may not be substantially damaged even when heat propagates.

The impact-resistant binder is or includes, for example, at least one of, or a mixture of two or more of, an elastomer, polyurethane-based, silicone-based, and hyperbranch binders.

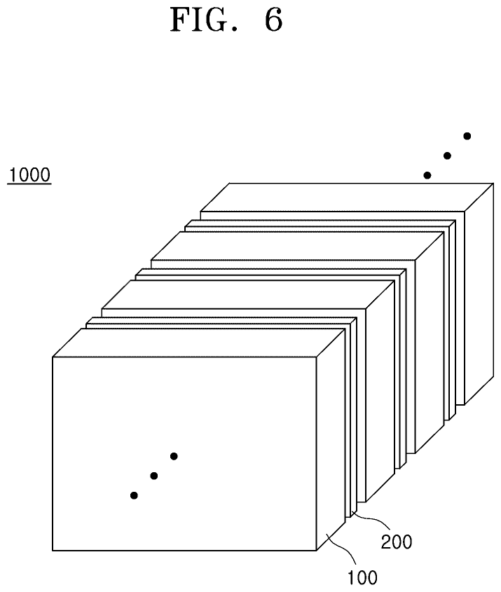

FIG. 9 is a cross-sectional view of an insulation sheet, according to one example embodiment.

In FIG. 9, the reference numeral 200 denotes the insulation sheet 200 described above with reference to FIGS. 6 to 8.

The insulation sheet 200 according to one example embodiment includes a first layer 210, a second layer 220, and a third layer 230.

The third layer 230 has heat storage characteristics.

In an example, the third layer 230 includes a phase change material (PCM). For example, the PCM includes at least one of, or a mixture of two or more of, paraffin, an inorganic salt, a salt hydrate, a carboxylic acid, and sugar alcohol.

For example, the third layer 230 may be formed in a sheet shape in a solid state. The third layer 230 may be formed on one surface of the second layer 220.

For example, the insulation sheet 200 includes one or more first layers 210, one or more second layers 220 stacked on the first layer 210, and one or more third layers 230 stacked on one surface of the second layer 220.

For example, as shown in FIG. 9, the insulation sheet 200 includes the first layer 210, the second layer 220 in contact with one surface of the first layer 210, and the third layer 230 in contact with one surface of the second layer 220.

For example, unlike the configuration shown in FIG. 9, the insulation sheet 200 may include the first layer 210, the third layer 230 in contact with one surface of the first layer 210, and the second layer 220 in contact with one surface of the third layer 230.

In this case, through the heat storage characteristics, the third layer 230 can reduce or prevent heat from being transferred from the inside and/or outside to the second layer 220. The third layer 230 reduces or prevents an organic binder located inside the second layer 220 from being damaged by heat transfer. Accordingly, the third layer 230 can improve the thermal conductivity of the insulation sheet 200.

Unlike the configuration shown in FIG. 9, the third layer 230 is formed in a solution or slurry state and/or formed in the form of powder in a solid state. The third layer 230 may be added to the second layer 220 and mixed with the second layer 220. For example, the third layer 230 may be added to a slurry including the second layer 220 and a binder to be applied on the first layer 210. In this case, the binder is included to assist in mixing and attaching the third layer 230 and the second layer 220 together. The binder includes, for example, a PVA-based binder. A mixed layer including the second layer 220, the third layer 230 and the binder may include, for example, the second layer 220 in a content in a range of about 40 wt % to about 60 wt %, the third layer 230 in a content in a range of about 5 wt % to about 15 wt %, and the binder in a content in a range of about 30 wt % to about 50 wt %.

In this case, most of the organic binder included in the second layer 220 may not be damaged because external heat transfer is reduced or prevented by the third layer 230. Accordingly, the third layer 230 can improve the thermal conductivity of the insulation sheet 200.

Through such a configuration, the insulation sheet 200 according to one example embodiment can provide an insulation sheet 200 with further improved thermal conductivity.

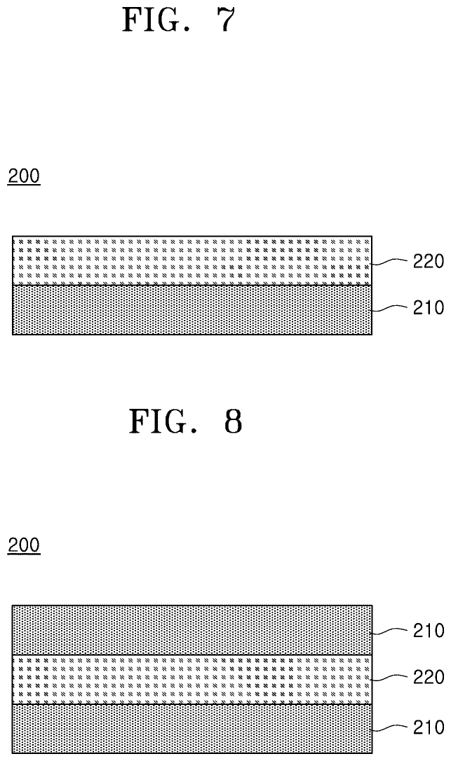

FIG. 10 is a cross-sectional view of an insulation sheet. according to one example embodiment.

In FIG. 10, the reference numeral 200 denotes the insulation sheet 200 described above with reference to FIGS. 6 to 9.

The insulation sheet 200 according to one example embodiment includes a first layer 210, a second layer 220, and a third layer 230.

As shown in FIG. 10, for example, the insulation sheet 200 has two or more first layers 210, one or more second layers 220, and/or two or more third layers 230. For example, the insulation sheet 200 has a configuration in which the first layers 210, the second layer(s) 220, and the third layers 230 are in a stacked configuration.

For example, the insulation sheet 200 includes the first layer 210, the third layer 230 stacked on one surface of the first layer 210, and the second layer 220 stacked on one surface of the third layer 230. In addition, the insulation sheet 200 further includes the third layer 230 stacked on one surface of the second layer 220, and the first layer 210 stacked on one surface of the third layer 230. That is, the insulation sheet 200 includes the second layer 220, the third layers 230 formed on both surfaces of the second layer 220, and the first layers 210 covering both surfaces of the third layers 230.

Through such a configuration, the insulation sheet 200 according to one example embodiment has desired or improved supporting force and improved thermal conductivity.

Alternatively, unlike that shown in FIG. 10, the insulation sheet 200 may include a mixed layer in which the second layer 220 and the third layer 230 are located between two first layers 210 and are mixed with each other.

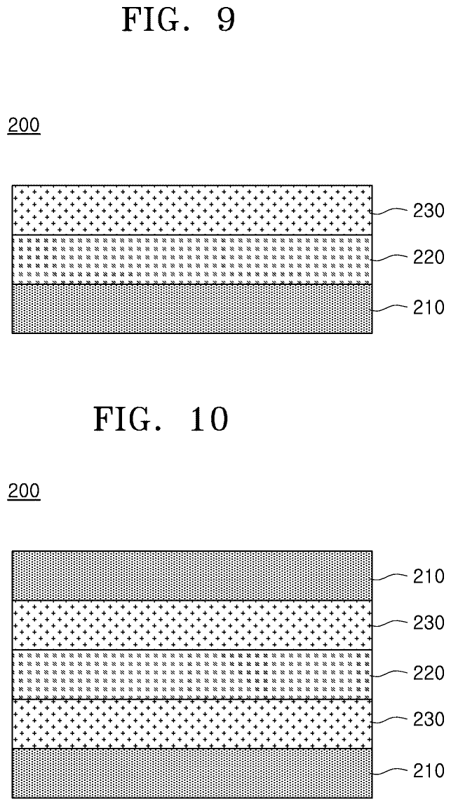

FIG. 11 is a cross-sectional view of an insulation sheet, according to one example embodiment.

In FIG. 11, the reference numeral 200 denotes the insulation sheet 200 described above with reference to FIGS. 6 to 10.

The insulation sheet 200 according to one example embodiment includes a first layer 210, a second layer 220, and a coating layer 240.

The coating layer 240 is a coating layer formed at an outer portion of the insulation sheet 200. The coating layer 240 has fire resistance properties to withstand heat during heat propagation. In addition, the coating layer 240 can improve the mechanical strength of the insulation sheet 200 and/or may also reduce any dust generated from the insulation sheet 200.

For example, the coating layer 240 includes a fiber. For example, the coating layer 240 includes at least one of, or a mixture of two or more of, glass wool, rock wool, glass fiber, rock wool, gypsum fiber, silica fiber, alumina fiber, zirconia fiber, and carbon fiber, which are inorganic materials in the form of fiber.

As shown in FIG. 11, the coating layer 240 is configured to surround one outer surface of at least one of the insulation sheets 200 described above with reference to FIGS. 6 to 10. For example, the coating layer 240 may be formed only on one outer surface of the insulation sheet 200. For example, one outer surface is a surface that is substantially perpendicular to a direction in which the first layer 210 and the second layer 220 are stacked, and is one of four outer surfaces of the insulation sheet 200. Alternatively, for example, the coating layer 240 may be formed on two or more outer surfaces of the insulation sheet 200. For example, the two or more outer surfaces are substantially perpendicular to the direction in which the first layer 210 and the second layer 220 are stacked, and are two or more of the four outer surfaces of the insulation sheet 200. In this case, the two or more outer surfaces may be located to face each other, or may be located adjacent to each other. Alternatively, for example, the coating layer 240 may be configured to surround all surfaces of the insulation sheet 200. All the surfaces of the insulation sheet 200 include four side surfaces of the insulation sheet 200 and upper and lower surfaces of the insulation sheet 200. At least one of the upper and lower surfaces of the insulation sheet 200 is one surface of the first layer 210.

Accordingly, for example, the insulation sheet 200 includes the coating layer 240 formed on at least one surface of outer surfaces of a stack structure including the second layer 220, and the first layers 210 formed on both surfaces of the second layer 220.

Through such a structure, the insulation sheet 200 according to one example embodiment can improve an effect of removing dust that may occur in the insulation sheet 200 and/or components included in the insulation sheet 200. In addition, the insulation sheet 200 may have improved fire resistance properties and mechanical strength, and thus may not be damaged, or be less damaged, even during heat propagation.

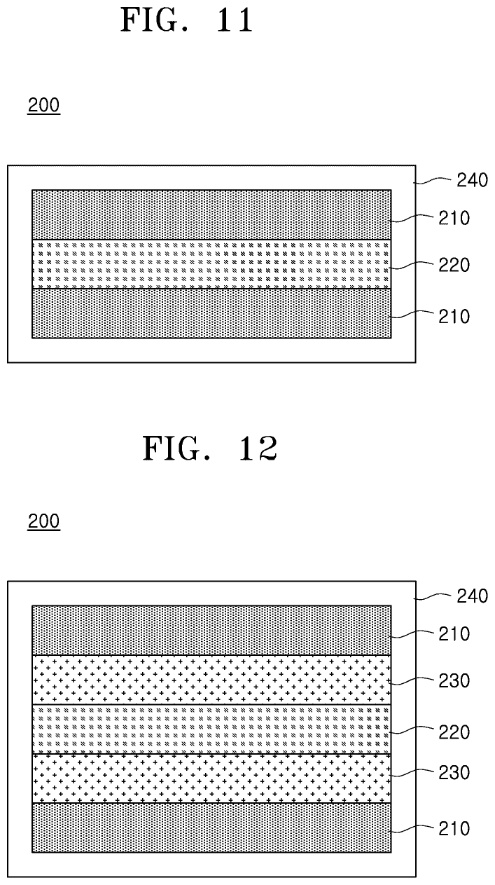

FIG. 12 is a cross-sectional view of an insulation sheet, according to one example embodiment.

In FIG. 12, the reference numeral 200 denotes the insulation sheet 200 described above with reference to FIGS. 6 to 11.

The coating layer 240 described with reference to FIG. 11 may be applied to any insulation sheet of the insulation sheets described above with reference to FIGS. 6 to 11. For example, the coating layer 240 may be included in the insulation sheet illustrated with reference to FIG. 10. In this case, as shown in FIG. 12, the insulation sheet 200 includes the coating layer 240 surrounding at least a portion of an outer surface of a stack including a second layer 220, third layers 230 formed on both surfaces of the second layer 220, and first layers 210 each formed on one surface of one of the third layers 230.

As such, the insulation sheet 200 according to one example embodiment further includes the coating layer 240, thereby providing an insulation sheet having not only improved fire resistance and mechanical properties, but also dust reduction effects.

The battery cell 100 and/or battery module 1000 illustrated in FIG. 6 according to one example embodiment of the present disclosure may be applicable to, e.g., vehicle, mobile phones, and/or various types of electrical devices, but the present disclosure is not limited thereto.

Hereinafter, examples and comparative examples of the present disclosure are described. However, the following examples are merely examples of the present disclosure, and the present disclosure is not limited to the following examples.

### Example 1: Preparation of Composition for Second Layer 220

A first mixed solution was prepared by adding PVA (manufactured by Sigma-Aldrich Co. LLC.) as a binder to ultrapure water as a solvent and mixing with an open blade at a speed of 30 rpm and a Despa blade at a speed of 700 rpm. A second mixed solution was prepared by adding Aerogel (with a Brunauer-Emmett-Teller (BET) specific surface area of 800 m²/g) to the first solution and mixing with an open blade at a speed of 70 and a Despa blade at a speed of 1,500 rpm. A third mixed solution was prepared by adding Glass wool to the second mixed solution and mixing with an open blade at a speed of 30 rpm and a Despa blade at a speed of 1,200 rpm. An additive was added to the third mixed solution, and a composition for a second layer 220 was prepared. A planetary mixer (PT-005 manufactured by DNTECH) was used during mixing.

The composition for the second layer 220 prepared above is in the form of a slurry, and a solid content thereof includes aerogel in a content of 45 wt %, glass wool in a content of 50 wt %, PVA in a content 4.9 wt %, and a silicone-based leveling agent (BYK-348) in a content of 0.1%.

### Manufacturing of Insulation Sheet 200

The composition for the second layer 220 prepared above was applied on a 0.1 mm thick mica sheet (muscovite manufactured by PAMICA Electric Material (Hubei) Co., Ltd.) as a first layer 210, a 0.1 mm thick mica sheet (muscovite manufactured by PAMICA Electric Material (Hubei) Co., Ltd.) as a first layer 210 was stacked on the composition for the second layer 220, and coating was performed through a rolling method. Subsequently, drying was performed at a temperature of 60° C. for 24 hours to manufacture a base sheet in which the first layer 210, the second layer 220, and the first layer 210 were sequentially stacked.

A thickness of the second layer 220 of a manufactured insulation sheet 200 is 2.2 mm.

### Example 2

An insulation sheet 200 was manufactured in the same manner as in Example 1, with a difference that the solid content of the compositions for the second layer 220 in Example 1 was changed to aerogel in a content of 45 wt %, glass wool in a content of 50 wt %, PVA in a content 4.9 wt %, and a silicone-based defoamer (BYK-019) in a content of 0.1%.

### Example 3

An insulation sheet 200 was manufactured in the same manner as in Example 1, with a difference that the solid content of the compositions for the second layer 220 in Example 1 was changed to aerogel in a content of 45 wt %, glass wool in a content of 50 wt %, PVA in a content 4.9 wt %, and a polyester-based dispersant (DISPERBYK-2151) in a content of 0.1%.

### Example 4

An insulation sheet 200 was manufactured in the same manner as in Example 1, with a difference that the solid content of the compositions for the second layer 220 in Example 1 was changed to aerogel in a content of 45 wt %, glass wool in a content of 50 wt %, PVA in a content 4 wt %, and a silicone-based leveling agent (BYK-348) in a content of 0.1%.

### Comparative Example 1

An insulation sheet 200 was manufactured in the same manner as in Example 1, with a difference that the solid content in the composition for the second layer in Example 1 was changed to aerogel in a content of 45 wt %, glass wool in a content of 50 wt %, and PVA in a content of 5 wt %.

Table 1 below shows the compositions and corresponding physical properties of Examples 1 to 5 and Comparative Example 1.

TABLE 1

| | Aerogel-containing layer | | | | | Insulation | Flame |
|---|---|---|---|---|---|---|---|
| | | Glass | | | Density | Property | Resistance |
| | Aerogel | wool | Binder | Additive | (g/cm²) | (° C.) | (s) |
| Example 1 | 45 | 50 | 4.9 | 0.1 | 0.30 | 79.2 | 710 |
| Example 2 | 45 | 50 | 4.9 | 0.1 | 0.31 | 80.9 | 716 |
| Example 3 | 45 | 50 | 4.9 | 0.1 | 0.29 | 81.4 | 709 |
| Example 4 | 45 | 50 | 4 | 1 | 0.30 | 80.5 | 711 |
| Example 5 | 45 | 50 | 2.5 | 2.5 | 0.31 | 81.1 | 720 |
| Comparative | 45 | 50 | 5 | 0 | 0.17 | 120.3 | 283 |
| Example | | | | | | | |

The following physical properties were evaluated on the insulation sheets manufactured in Examples and Comparative Examples.
(1) Density: the manufactured insulation sheet was cut to have a size of 100 mm length and 100 mm width to manufacture a specimen, and the weight of the specimen was measured. A 0.1 mm thick mica sheet (muscovite manufactured by PAMICA Electric Material (Hubei) Co., Ltd.) was cut to have a size of a 100 mm length and 100 mm width, the weight thereof was measured, and the density of the second layer was measured after subtracting the weight of the mica sheet from the weight of the insulation sheet measured above.
(2) Insulation property evaluation: the manufactured insulation sheet was cut to have a size of 232 mm length and 115 mm width to manufacture a specimen, each insulation sheet was placed between a pair of opposing 1 mm thick aluminum plates, and the insulation sheet was placed on a heat press. An upper plate of the hot press was heated to a temperature of 350° C., and a lower plate of the hot press was maintained at a starting temperature of 40° C. without heating. Subsequently, a pressure of 20 kN is applied to the lower plate of the hot press and a temperature of the lower plate of the heat press was measured after 11 minutes. The lower the temperature of the lower plate, the better the insulation properties of the insulation sheet.
(3) Flame resistance property (unit: second): the manufactured insulation sheet was cut to have a size of a 100 mm length and a 70 mm width to manufacture a specimen, and a temperature sensor was attached to the insulation sheet. By using a torch capable of emitting a flame onto the mounted specimen, a flame was applied such that a temperature of a surface of the insulation sheet reached a temperature of 1,200° C. In this case, a time at which cracks occur on an exterior of the insulation sheet and the insulation sheet collapses was cheeked. The longer the time, the better flame resistance properties to flame passage.

According to an insulation sheet and/or a rechargeable battery module including the insulation sheet according to one example embodiment, heat propagation between adjacent cells can be reduced or suppressed.

According to an insulation sheet and/or a rechargeable battery module including the insulation sheet according to one example embodiment, fire resistance and/or insulation properties can be improved.

According to an insulation sheet and/or a rechargeable battery module including the insulation sheet according to one example embodiment, thermal conductivity can be improved.

An insulation sheet according to one example embodiment can be reduced or prevented from being damaged even when heat propagation occurs.

An insulation sheet according to one example embodiment can have a dust reduction effect.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. An insulation sheet comprising:
one or more first layers; and
one or more second layers alternately stacked with the one or more first layers,
wherein at least one of the one or more second layers comprises an insulation material and an additive configured to improve a coating uniformity thereof.

2. The insulation sheet of claim 1, wherein the one or more first layers are formed on both surfaces of one of the one or more second layers.

3. The insulation sheet of claim 1, wherein the additive comprises at least one of a leveling agent, a defoamer, a dispersant, and a combination thereof.

4. The insulation sheet of claim 1, wherein the additive comprises at least one of a silicone-based polymer, a polyester-based polymer, a fluorine-based polymer, and a combination thereof.

5. The insulation sheet of claim 1, wherein the one or more first layers comprise at least one of, or a mixture of two or more of, mica, fiber, sericite, talc, diatomaceous earth, bentonite, silicon, elvan, kaolin, polyimide, and polyethylene terephthalate.

6. The insulation sheet of claim 1, wherein the one or more second layers comprise at least one of, or a mixture of two or more of, aerogel, wet silica, dry silica, polyurethane, polystyrene, polyethylene, and polyester.

7. The insulation sheet of claim 1, further comprising one or more third layers on one surface of one of the one or more second layers, the one or more third layers comprising a phase change material.

8. The insulation sheet of claim 7, wherein the one or more third layers are formed on both surfaces of the one or more second layers to form a stack together with the one or more second layers, and
the one or more first layers are formed on both surfaces of the stack.

9. The insulation sheet of claim 7, wherein the one or more third layers comprise at least one of, or a mixture of two or more of, paraffin, an inorganic salt, a salt hydrate, a carboxylic acid, and sugar alcohol.

10. A battery module comprising:
a plurality of battery cells;
an insulation sheet located in at least one gap between the plurality of battery cells; and
a housing in which the battery cell and the insulation sheet are accommodated;
wherein the insulation sheet comprises:
one or more first layers; and
one or more second layers alternately stacked with the one or more first layers,
wherein at least one of the one or more second layers comprises an insulation material and an additive configured to improve coating uniformity thereof.

11. A battery module of claim 10, wherein the one or more first layers are formed on both surfaces of one of the one or more second layers.

12. A battery module of claim 10, wherein the additive comprises at least one of a leveling agent, a defoamer, a dispersant, and a combination thereof.

13. A battery module of claim 10, wherein the additive comprises at least one of a silicone-based polymer, a polyester-based polymer, a fluorine-based polymer, and a combination thereof.
